(19) United States
(12) Patent Application Publication
(10) Pub. No.: US 2016/0375892 A1
(43) Pub. Date: Dec. 29, 2016

(54) SYSTEM AND METHOD FOR ENGINE STOP CONTROL OF HYBRID VEHICLE

(71) Applicant: Hyundai Motor Company, Seoul (KR)

(72) Inventor: Sang Joon Kim, Seoul (KR)

(21) Appl. No.: 14/952,088

(22) Filed: Nov. 25, 2015

(30) Foreign Application Priority Data
Jun. 26, 2015 (KR) 10-2015-0091367

(51) Int. Cl. B60W 20/13; B60W 10/08; B60W 10/06

(52) U.S. Cl. CPC B60W 20/13; B60W 10/06; B60W 10/08; B60W 2710/06; B60W 2710/083

(57) ABSTRACT

An engine stop control system for a hybrid vehicle, which enters an EV mode while being driven in an HEV mode, includes: a driving information detecting unit which detects information of reduced or increased speed and a gradient of a road, a second motor which applies a charging torque to stop an engine rotation speed, a motor controller having a plurality of power switching elements to convert a DC voltage which is supplied from a battery in accordance with an applied control signal into a three phase AC voltage to control a first motor and the second motor, and a hybrid control unit which sets a charging torque command which has a maximum charging power in accordance the speed of the second motor.

### CROSS-REFERENCE TO RELATED APPLICATION

This application claims under 35 U.S.C. §119(a) the benefit of Korean Patent Application No. 10-2015-0091367 filed in the Korean Intellectual Property Office on Jun. 26, 2015, the entire contents of which are incorporated herein by reference.

### BACKGROUND

(a) Field of the Invention

The present invention relates to a system and a method for engine stop control of a hybrid vehicle, and more particularly, to a system and a method for engine stop control which improves reacceleration responsiveness in accordance with demand of a driver after stopping an engine of the hybrid vehicle.

(b) Description of the Related Art

Generally, a hybrid vehicle (Hybrid Electric Vehicle/Plug-in Hybrid Electric Vehicle, HEV/PHEV) is a vehicle which uses two or more different types of power sources, for example, an engine which obtains driving torque by combusting fuel and a motor which obtains driving torque by battery power.

In a conventional internal combustion engine vehicle of the related art, a brake plays an important role of braking but paradoxically, when a driver applies the brake to stop the vehicle or reduce a speed, the vehicle needs to be reaccelerated to recover a predetermined speed, so that a lot of fuel is consumed. Generally, this is the reason why fuel consumption is reduced in congested areas of a city where the driver frequently applies the brake as compared with highway travel.

In contrast, it is known that in a driving circumstance where the engine inefficiently operates, the hybrid vehicle increases efficiency by charging and discharging a battery using a motor and stores kinetic energy which is generated at the time of stopping the vehicle or reducing the speed in the battery to be reused, so that it is advantageous in reducing fuel consumption.

FIG. 1 (RELATED ART) is a block diagram schematically illustrating a system of a hybrid vehicle of the related art.

Referring to FIG. 1, a hybrid vehicle of the related art uses a transmission mounted electric vehicle (TMED) type power train in which an engine, a clutch, a first motor, and an automatic transmission (AT) are connected in series to a driving shaft.

In such a hybrid vehicle, differently from a general gasoline vehicle, a second motor is mounted, instead of a starter motor for starting the engine, not only to start the engine, but also to charge a battery in an electric vehicle (EV) mode and a long slope situation.

In the case of the hybrid vehicle, an HEV mode by starting the engine and engaging the clutch and an EV mode by stopping the engine and disengaging the clutch are frequently switched in accordance with a driver's demand and driving circumstances.

Particularly, when the engine of the hybrid vehicle which is being activated stops, in order to quickly avoid an engine resonance area, a reverse torque is applied by a second motor which is connected to the engine to quickly stop the engine, thereby reducing vibration.

However, when the reverse torque is quickly applied by the second motor, an engine rotation speed is quickly lowered and in this case, when the driver requests to reaccelerate the vehicle, an engine rotation speed needs to be increased again in order to engage the clutch to connect the engine to the driving shaft. However, time delay occurs so that reacceleration performance deteriorates.

The above information disclosed in this Background section is only for enhancement of understanding of the background of the invention and therefore it may contain information that does not form the prior art that is already known in this country to a person of ordinary skill in the art.

The above information disclosed in this Background section is only for enhancement of understanding of the background of the invention and therefore it may contain information that does not form the prior art that is already known in this country to a person of ordinary skill in the art.

### SUMMARY

The present invention provides a system and a method for engine stop control of a hybrid vehicle in order to improve reacceleration delay which may be generated by charging control by a second motor at the time of stopping an engine of a hybrid vehicle.

An exemplary embodiment of the present invention provides an engine stop control system of a hybrid vehicle which enters an EV mode while being driven in an HEV mode, the system including a driving information detecting unit which detects information of reduced or increased speed which is requested by a driver and a gradient of a road, a second motor which applies a charging torque to stop the engine rotation speed, when the engine stops, a motor controller which is configured by a plurality of power switching elements to convert a DC voltage which is supplied from the battery in accordance with an applied control signal into a three phase AC voltage to control a first motor and the second motor, and a hybrid control unit which sets a charging torque command which has a maximum charging power in accordance the speed of the second motor, in which the hybrid control unit resets the charging torque command by a value mapped in consideration of an available torque of the first motor and a variable factor of a downhill gradient to generate a final second motor charging torque command and applies the final second motor charging torque command to the second motor through the motor controller.

When the first motor is in an RPM area which is lower than a predetermined reference speed and the available power of the first motor is equal to or higher than a predetermined SOC, the hybrid control unit may determine that the acceleration performance of the first motor is secured referring to the performance curve of the first motor.

When the hybrid vehicle is driven on a downhill road having a lower driving resistance, the hybrid control unit may determine that acceleration performance is secured in accordance with the gradient of the road.

Further, the driving resistance may include a rolling resistance, an air resistance, and a slope resistance which accelerates the hybrid vehicle on the downhill road.

In a sport mode which requires a rapid acceleration response, the hybrid control unit may not apply the charging torque to the second motor.

The final second motor charging torque command may be reset to approximate the charging torque command as the available torque is increased and reset to approximately zero as the available torque is reduced.

Further, the final second motor charging torque command may be reset to approximate the charging torque command as a gradient of the downhill road is increased and reset to approximately zero as the gradient of the downhill road is reduced.

Further, the final second motor charging torque command may be reset as a value obtained by adding a value mapped to the available torque of the first motor and a value which is mapped to the road gradient.

In the meantime, another exemplary embodiment of the present invention provides an engine stop control method of a hybrid vehicle which enters an EV mode while being driven in an HEV mode, including: a) stopping an engine and disengaging the engine and the driving shaft, b) setting a charging torque command at which a maximum charging power is obtained in accordance with a speed of the second motor, c) applying values which are mapped to the available torque of the first motor and variable factors of the road gradient to the charging torque command to reset the charging torque command as a final second motor charging torque command; and d) applying the final second motor charging torque command to the second motor to stop the engine and collect the generated energy.

Further, between step a) and step b), when the hybrid vehicle is a sport mode which requires a rapid acceleration response, the charging torque may not be applied to the second motor.

Further, in step c), the final second motor charging torque command is reset to approximate the charging torque command as the available torque is increased and reset to approximately zero as the available torque is reduced.

Further, in step c), the final second motor charging torque command may be reset to approximate the charging torque command as a gradient of the downhill road is increased and may be reset to approximately zero as the gradient of the downhill road is reduced.

Further in step c), the final second motor charging torque command may be reset as a value obtained by adding a value mapped to the available torque of the first motor and a value which is mapped to the road gradient.

Further, after step d), when a driver requests reacceleration, the engine may be connected to the driving shaft by raising an engine speed by the second motor while performing the reacceleration starting using the available torque of the first motor. A non-transitory computer readable medium containing program instructions executed by a processor can include: program instructions that stop starting of an engine and disengage the engine and a driving shaft; program instructions that set a charging torque command at which a maximum charging power is obtained in accordance with a speed of a second motor; program instructions that apply values which are mapped to an available torque of a first motor and variable factors of a road gradient to the charging torque command to reset the charging torque command as a final second motor charging torque command; and program instructions that apply the final second motor charging torque command to the second motor to stop the engine and collect the generated energy.

According to an exemplary embodiment of the present invention, when the engine of the hybrid vehicle stops, the first motor available torque and a driving gradient are monitored to check the acceleration performance and control the second motor charging torque adjusted thereby to improve the acceleration responsiveness in accordance with the reacceleration request of the driver.

Further, even when the engine stops, if the acceleration performance of the first motor is large, the charging torque of the second motor is controlled to maximize an energy recovery rate, thereby securing the reacceleration responsiveness and improving fuel consumption.

### BRIEF DESCRIPTION OF THE DRAWINGS

FIG. 1 (RELATED ART) is a block diagram schematically illustrating a system of a hybrid vehicle of the related art.

FIG. 2 is a block diagram schematically illustrating a configuration of an engine stop control system of a hybrid vehicle according to an exemplary embodiment of the present invention.

FIGS. 3 and 4 are graphs explaining that reacceleration delay occurs when an engine generally stops.

FIG. 5 is a graph of a performance curve of a first motor according to an exemplary embodiment of the present invention.

FIG. 6 is a block diagram of a motor control logic in consideration of reacceleration response according to an exemplary embodiment of the present invention.

FIG. 7 is a flowchart schematically illustrating an engine stop control method of a hybrid vehicle according to an exemplary embodiment of the present invention.

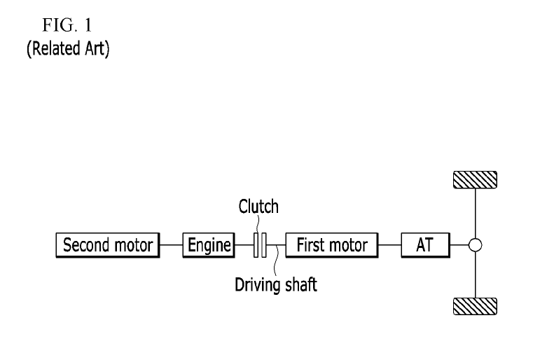

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

In addition, some methods may be performed by at least one controller. The term controller refers to a hardware device including a memory and a processor which is configured to execute at least one step which is interpreted as an algorithm structure. The memory is configured to store algorithm steps and the processor is configured to specifically execute the algorithm steps in order to perform at least one process which will be described below.

Further, a control logic of the present invention may be implemented by a computer readable medium, which is not temporal, on a computer readable means including executable program commands which are executed by a processor, a controller or a similar unit. Examples of the computer readable means are not limited to this, but include a ROM, a RAM, a CD-ROM, a magnetic tape, a floppy disk, a flash drive, a smart card, and an optical data storing device. A computer readable reproducing medium is distributed in computer systems which are connected by a network, for example, to be stored and executed by a distributing method by a telematics server or a controller area network (CAN).

Now, an engine stop control system of a hybrid vehicle and an engine stop control method according to an exemplary embodiment of the present invention will be described in detail with reference to the drawings.

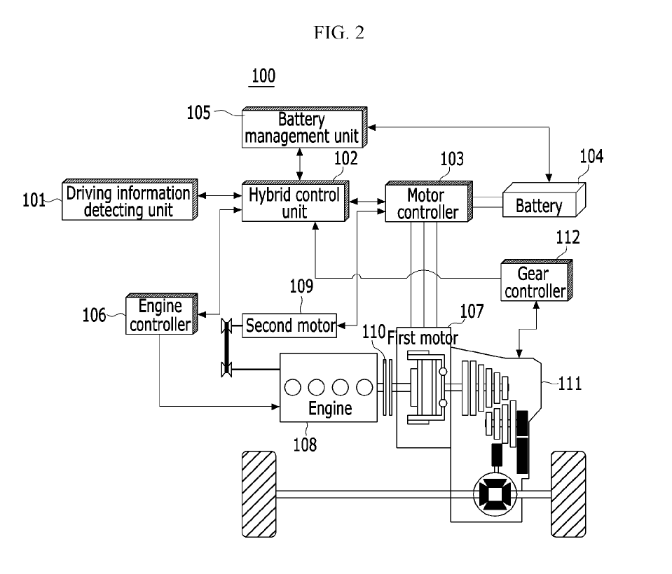

FIG. 2 schematically illustrates a configuration of an engine stop control system of a hybrid vehicle according to an exemplary embodiment of the present invention. Referring to FIG. 2, an engine stop control system 100 of a hybrid vehicle according to an exemplary embodiment of the present invention includes a driving information detecting unit 101, a hybrid control unit 102, a motor controller 103, a battery 104, a battery management unit 105, an engine controller 106, a first motor 107, an engine 108, a second motor 109, a clutch 110, a transmission 111, and a transmission controller 112.

The driving information detecting unit 101 detects information of reduced or increased speed demanded by a driver and provides the detected information to the hybrid control unit 102.

The driving information detecting unit 101 may collect driving information in accordance with driving of the hybrid vehicle, from at least one of a brake pedal sensor (BPS) which detects an operating displacement of a brake pedal, an accelerator pedal sensor (APS) which detects an operating displacement of an accelerator pedal, a vehicle speed sensor which detects a speed of the hybrid vehicle, an acceleration sensor which detects an acceleration of the hybrid vehicle, a gear sensor which detects a gear which is currently engaged, a revolutions per minute (RPM) sensor which detects a number of resolution of the engine 108, a resolver which detects a speed of the first motor 107 and an angle of a rotor, and a gradient sensor which measures a gradient of a road.

The hybrid control unit 102 is a top level controller of the hybrid vehicle and collectively controls the controllers which are connected by a network.

The hybrid control unit 102 is connected to the controllers by a high speed CAN communication line to exchange information therebetween and performs cooperative control to control output torques of the engine 108 and the first motor 107.

The hybrid control unit 102 checks a driver request torque provided from the driving information detecting unit 101 and a state of charge (SOC) of the battery 104 which is provided by the battery management unit 105 in a state where the vehicle starts the engine 108 and then is driven in an EV mode and determines to start the engine 108 when it is required to switch into a HEV mode. Further, the clutch 110 which is mounted between the engine 108 and the first motor 107 is engaged to control HEV mode driving.

The hybrid control unit 102 calculates the driver request torque using an APS displacement value by a pedal effort of the driver which presses the accelerator pedal. Further, when the vehicle is driven on an uphill road, the hybrid control unit 102 further reflects an uphill gradient to calculate a driver request torque.

When the calculated driver request torque exceeds a threshold torque which is required to enter the HEV mode, the hybrid control unit 102 may determine to start the engine 108 in order to switch the mode into the HEV mode.

Further, when the SOC of the battery is reduced in accordance with the EV driving to be lower than a threshold SOC at which electricity needs to be generated by the engine 108, the hybrid control unit 102 may also determine to start the engine to switch the mode into the HEV mode.

The motor controller 103 is configured by a plurality of power switching elements and converts a DC voltage which is supplied from the battery 104 in accordance with a control signal applied from the hybrid control unit 102 into a three phase AC voltage to control the first motor 107 and the second motor 109.

The power switching elements which configure the motor controller 103 may be configured by any one of an insulated gate bipolar transistor (IGBT), a MOSFET, a transistor, and a relay.

The battery 104 is configured by a plurality of unit cells and a high voltage which is supplied to the first motor 107, for example, voltage of DC 400 V to 450 V may be stored.

The battery management unit 105 detects a current, a voltage, and a temperature of the cells in an operating area of the battery 104 to manage the state of charge (SOC) and controls a charged and discharged voltage of the battery 104 to prevent the battery from being over-discharged to be below a limited voltage or overcharged to be over the limited voltage to shorten a lifespan.

The engine controller 106 controls the engine 108 in accordance with a command of the hybrid control unit 102 and monitors operating statuses (for example, an engine RPM or an engine torque) of the engine 108 to transmit the operating status to the hybrid control unit 102.

The first motor 107 operates by a three phase AC voltage which is applied from the motor controller 103 to generate a torque and operates as a generator when the vehicle is driven in a coasting mode to supply the regenerative energy to the battery 104.

The engine 108 is a power source and outputs engine power in a starting-on state.

The second motor 109 operates as a starter and a generator and starts the engine 108 in accordance with a control signal which is applied from the hybrid control unit 102 and transmits an engine starting bit in accordance with the completely started state to the hybrid control unit 102.

When the vehicle enters in the EV mode to stop the started engine 108, the second motor 109 operates as a generator which applies a charging torque which reduces the engine speed (rpm) to recover the energy.

Further, the second motor 109 operates as a generator while the engine 108 is maintained to be started on, to generate voltage and provides the generated voltage to the battery 104 through the motor controller 103 as a charging voltage.

The second motor 109 may be connected to the engine 108 through a belt, as illustrated in FIG. 2 or directly connected thereto by a shaft.

The clutch 110 is disposed between the engine 108 and the first motor 107 to drive the vehicle in the EV mode and the HEV mode.

In the EV mode, the clutch 110 releases the connection of the engine 108 and the driver shaft and when the mode is switched in the HEV mode due to reacceleration request by the driver, connects the engine 108 and the driving shaft to transmit the driving torque of the engine.

The transmission 111 may be configured by an automatic transmission (AT) or a DCT (Dual Clutch Transmission) and a gear ratio is adjusted by the control of the hybrid control unit 102.

A transmission control unit (TCU) 112 automatically controls a target gear of the transmission 111 which is determined in accordance with a condition such as a vehicle speed, a throttle opening, or an input torque to maintain a vehicle speed which is appropriate to a current driving condition.

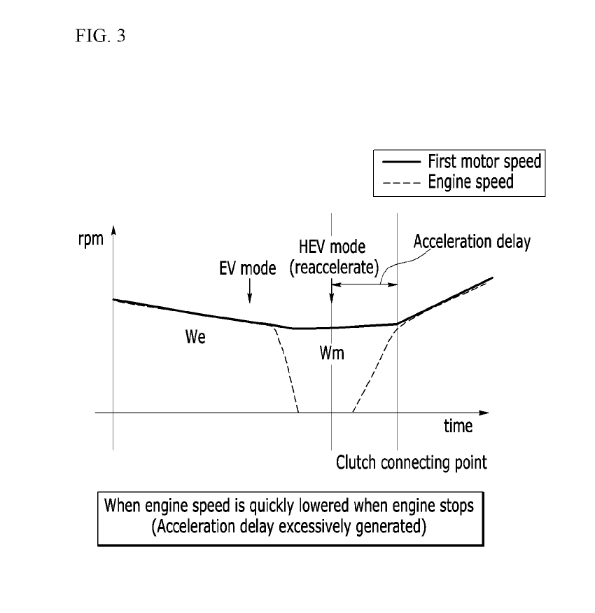

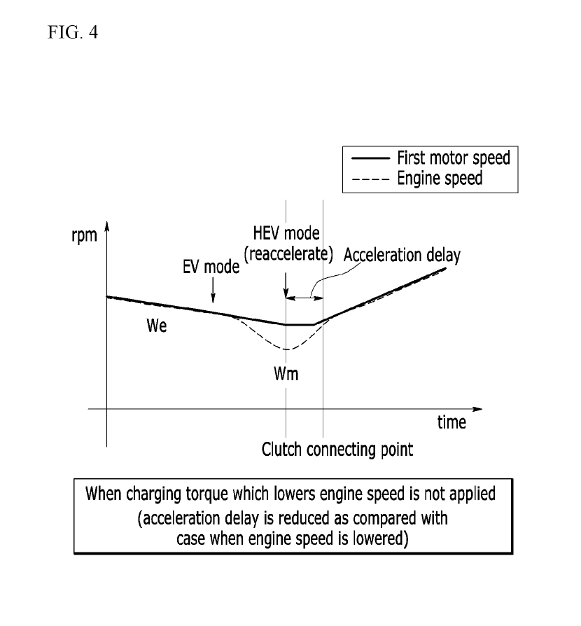

In the meantime, FIGS. 3 and 4 are graphs explaining that reacceleration delay occurs when an engine generally stops.

When the hybrid vehicle enters in the EV mode in accordance with the request of the driver to perform the engine stop control in a clutch disengagement state where the engine is separated from the driving shaft, if the driver puts the accelerator pedal in order to reaccelerate the vehicle, the vehicle needs to enter in the HEV mode.

In this case, the hybrid vehicle should connect the clutch at the engine side to the driving shaft again. In order to engage the clutch, the engine speed needs to be raised to a cultch engagement point which is synchronized with the speed of the first motor.

However, in FIG. 3, since the charging torque of the second motor is controlled to be advantageous to the fuel consumption, but the engine speed is quickly lowered, it takes lots of time to raise the engine speed again so that acceleration delay is excessively generated.

Further, in an example of FIG. 4, the charging torque which reduces the engine speed is not applied, so that the acceleration delay is reduced as compared with the case of FIG. 3 in which the engine speed is reduced, but it is disadvantageous to the fuel consumption.

Particularly, the reacceleration delay of the hybrid vehicle is deepened at the high speed due to the characteristic of the first motor because an available torque (dischargeable torque) of the first motor is small at a high speed. In other words, due to the limitation of the available torque of the first motor, when the hybrid vehicle is driven at a high speed, the reacceleration responsiveness may be secured only by adding the driving torque of the engine.

According to the above description, even though it is difficult to precisely determine what is to occur in the future, when the hybrid vehicle is not reaccelerated after entering the EV mode, if a large charging torque is applied to the second motor to lower the engine speed, it is advantageous to the fuel consumption. For example, the vehicle may be sufficiently reaccelerated only by the available torque of the first motor in a situation which is not a high speed driving condition or may be inertially driven in a continuous downhill section.

Further, the reacceleration responsiveness is obtained when the driving torque of the engine 108 is quickly connected to the driving shaft to quickly transmit the driving torque of the engine to the driving shaft. However, in the exemplary embodiment of the present invention, it should be noted that in addition to the driving torque of the engine, when the current available torque of the first motor 107 is large, it is possible to secure the acceleration response by the first motor 107.

By considering the above description, the hybrid control unit 102 according to the exemplary embodiment of the present invention monitors the available torque of the first motor 107 and a driving gradient in a state when the engine stops and processes the charging torque of the second motor 109 to perform the engine stop control which is advantageous in terms of the reacceleration performance and an energy recovery rate.

First, when a driving mode selected by the driver is a sport mode (also referred to as a dynamic mode) which requires a rapid response, the hybrid control unit 102 sets so as not to apply the charging torque to the second motor 109.

In contrast, when the driving mode is a normal mode or an eco mode for fuel consumption aimed driving, the hybrid control unit 102 sets to have a high energy recovery rate as much as possible.

When the engine power is not connected (the clutch is disengaged) due to the engine stop, the hybrid control unit 102 monitors whether to secure the acceleration responsiveness of the first motor 107 by referring to a performance curve of the first motor 107.

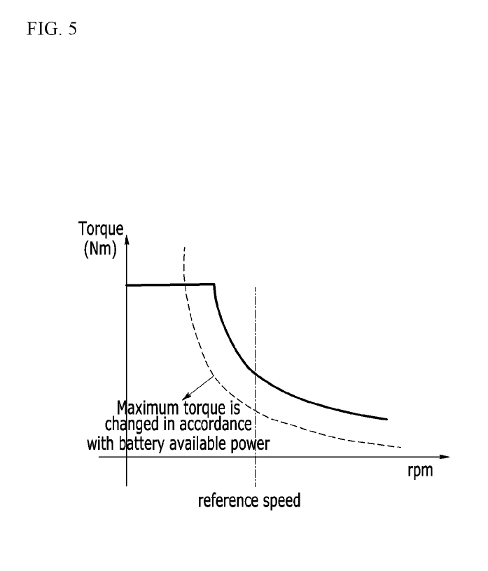

FIG. 5 illustrates a performance curve of the first motor according to an exemplary embodiment of the present invention.

Referring to FIG. 5, FIG. 5 illustrates a performance curve of the first motor 107 in accordance with a hardware performance in which a maximum torque may vary in accordance with the available power of the battery 104.

When the first motor 107 is in an RPM area which is lower than a predetermined reference speed and the available power of the battery 104 is equal to or higher than a predetermined SOC, the hybrid control unit 102 determines that the acceleration performance of the first motor 107 is secured with reference to the performance curve.

Further, when as a result of measuring a gradient of a road, the vehicle is driven on a downhill road having a low vehicle driving resistance, since an accelerating feeling which is felt by the driver is large even though the available torque of the first motor 107 is small, the hybrid control unit 102 may determine that the acceleration performance in accordance with the gradient of the road is secured.

Here, the driving resistance of the vehicle includes a rolling resistance, an air resistance, and a slope resistance and in the case of the downhill, the slope resistance serves to accelerate the vehicle.

As described above, the hybrid control unit 102 sets a command variable factor of a charging torque which is applied to the second motor 109 through the motor controller 103 at the time of stopping the engine 108, through correlation of the available torque (dischargeable torque) of the first motor 107 in accordance with the state of the battery 104 and the motor controller 103 and the gradient of the vehicle.

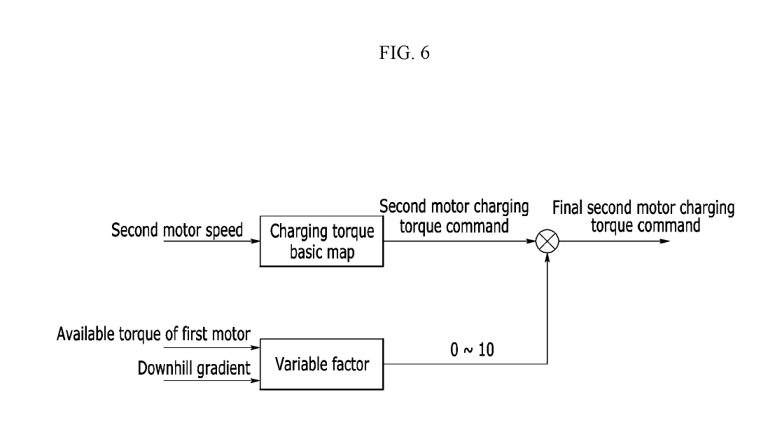

FIG. 6 illustrates a motor control logic in consideration of reacceleration response according to an exemplary embodiment of the present invention.

Referring to FIG. 6, when the speed of the second motor 109 is input in a state where the engine 108 stops, the hybrid control unit 102 generates a second motor charging torque command at a point which becomes a maximum charging power at every speed of the second motor in accordance with a predetermined charging torque basic map.

Here, the charging torque basic map is a map which is set to apply the charging torque to the second motor 109 so that the energy recovery rate in accordance with the speed of the second motor 109 is maximized.

In this case, the hybrid control unit 102 resets the second motor charging torque command by a value mapped in consideration of the available torque of the first motor 107 and a variable factor of the downhill gradient to generate a final second motor charging torque command and applies the final second motor charging torque command to the second motor 109 through the motor controller 103.

For example, the hybrid control unit 102 resets the final second motor charging torque command to approximate the charging torque command by which the energy recovery rate is maximum as the available torque of the first motor 107 is increased in a predetermined range and resets the final second motor charging torque command to approximately zero as the available torque is reduced.

Further, the hybrid control unit 102 resets the final second motor charging torque command to approximate the charging torque command by which the energy recovery rate is maximum as the downhill gradient is increased and resets the final second motor charging torque command to approximately zero as the downhill gradient is reduced.

For example, when a variable factor of the available torque or the downhill gradient is set to be zero to 10 levels, if the variable factor is 10 level, the hybrid control unit 102 applies the final second motor charging torque command to be maximum, which is similar to the charging torque command and if the variable factor is zero level, the hybrid control unit 102 may not apply the charging torque command to the second motor 109.

As described above, the hybrid control unit 102 controls the charging torque of the second motor 109 in accordance with a degree of securing the acceleration responsiveness in accordance with the available torque of the motor and the driving with the downhill gradient to recover the energy.

Further, when the driver requests reacceleration, the hybrid control unit 102 raises the speed of the engine 108 through the second motor 109 to be connected to the driving shaft while performing the reacceleration starting using the secured available torque of the first motor 107, so that the reacceleration responsiveness without having acceleration delay is secured.

In the meantime, a hybrid vehicle engine stop control method according to an exemplary embodiment of the present invention based on a configuration of the engine stop control system 100 of the hybrid vehicle described above will be described.

Processes of an engine stop control method of a hybrid vehicle according to an exemplary embodiment of the present invention which will be described below may be performed by being divided or combined by controllers. Therefore, the description will be made by considering a main agent which performs the above-described functions as the engine stop control system 100 without being stick to the name of the configuration in the exemplary embodiment of the present invention.

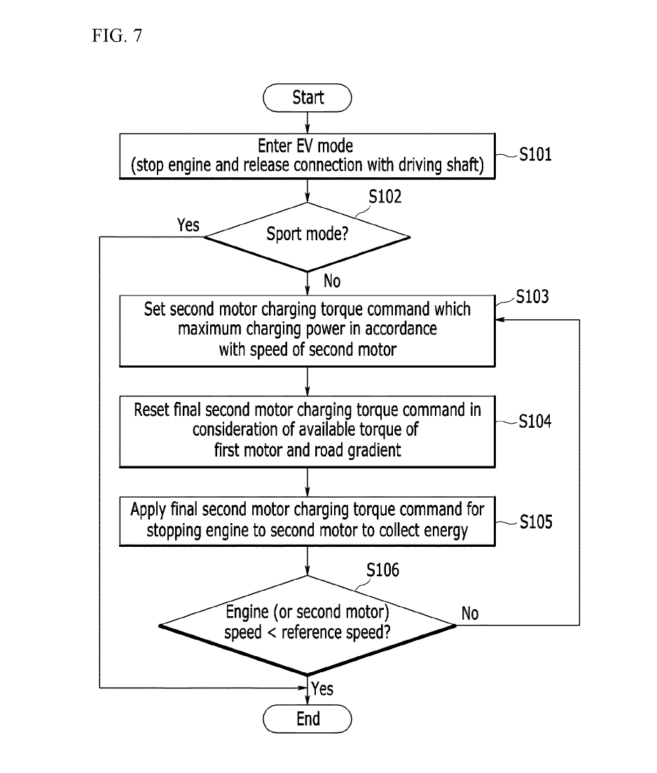

FIG. 7 is a flowchart schematically illustrating an engine stop control method of a hybrid vehicle according to an exemplary embodiment of the present invention.

Referring to FIG. 7, when a hybrid vehicle enters from an HEV mode to an EV mode, an engine stop control system 100 of a hybrid vehicle according to an exemplary embodiment of the present invention stops an engine 108 and releases the connection between the engine and a driving shaft in step S101.

When the vehicle is in a sport mode which requires a rapid acceleration response (Yes in step S102), the engine stop control system 100 does not apply a charging torque to the second motor 109.

In contrast, when the vehicle is not the sport mode, but a normal mode or an eco mode (No in step S102), the engine stop control system 100 performs the engine stop control which considers the reacceleration response which will be described below.

The engine stop control system 100 sets a second motor charging torque command at which the charging power is maximum in accordance with the speed of the second motor 109 by referring to a predetermined charging torque basic map in step S103.

The engine stop control system 100 applies values which are mapped to an available torque of the first motor 107 and variable factors of the road gradient to the second motor charging torque command to reset a final second motor charging torque command in step S104. Further, the engine stop control system 100 applies the final second motor charging torque command for stopping the engine 108 to the second motor 109 to recover the energy in step S105.

In this case, the final second motor charging torque command may be reset to approximate the charging torque command as the available torque is increased and reset to approximately zero as the available torque is reduced.

Further, the final second motor charging torque command may be reset to approximate the charging torque command as a gradient of a downhill road is increased and reset to approximately zero as the gradient of the downhill road is reduced.

Further, the final second motor charging torque command may be reset by a value obtained by adding a value which is mapped to the available torque of the first motor 107 and a value which is mapped to the road gradient.

For example, when a value which is mapped to the available torque is 5 and a value which is mapped to a downhill gradient is 5, if two mapped values are added, the result is 10. Therefore, the charging torque command which becomes the maximum charging power is applied as the final second motor charging torque command. This is because, since the vehicle is driven on the downhill road in a state when some of the available torque of the first motor is secured, acceleration responsiveness due to two factors is added to be increased.

In the meantime, when a speed of the engine 108 or the second motor 109 is equal to or larger to a predetermined reference speed (No in step S105), the engine stop control system 100 returns to step S103 to continuously perform the engine stop control.

In contrast, when the speed of the engine 108 or the second motor 109 is lower than a predetermined reference speed (Yes in step S105), the engine stop control system 100 stops the engine stop control.

Here, the reference speed may be set in a range where engine backlashing is not generated.

As described above, according to the exemplary embodiment of the present invention, when an engine of the hybrid vehicle stops, an available torque of the first motor and a driving gradient are monitored to confirm the acceleration performance and controls the second motor charging torque adjusted in accordance therewith, thereby improving resonance responsiveness in accordance with the reacceleration request of the driver.

Further, when the acceleration performance of the first motor is large even though the engine stops, the charging torque of the second motor is controlled so that the energy recovery rate is maximized to secure the reacceleration response and improve the fuel efficiency.

The exemplary embodiment of the present invention described above is implemented not only by way of an apparatus and a method described above, but also may be implemented by a program which executes a function corresponding to the configuration of the exemplary embodiment of the present invention or a recording medium in which the program is written and may be easily implemented by those skilled in the art from the description of the exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An engine stop control system of a hybrid vehicle which enters an electric vehicle (EV) mode while being driven in a hybrid electric vehicle (HEV) mode, the system comprising:
a driving information detecting unit which detects information of reduced or increased speed requested by a driver and a gradient of a road;
a second motor which applies a charging torque to stop an engine rotation speed, when an engine stops;
a motor controller which is configured by a plurality of power switching elements to convert a DC voltage which is supplied from the battery in accordance with an applied control signal into a three phase AC voltage to control a first motor and the second motor; and
a hybrid control unit which sets a charging torque command which has a maximum charging power in accordance the speed of the second motor,
wherein the hybrid control unit resets the charging torque command by a value mapped in consideration of an available torque of the first motor and a variable factor of a downhill gradient to generate a final second motor charging torque command and applies the final second motor charging torque command to the second motor through the motor controller.

2. The engine stop control system of claim 1, wherein:
when the first motor is in an RPM area which is lower than a predetermined reference speed and an available power of the battery is equal to or higher than a predetermined state of charge (SOC), the hybrid control unit determines that the acceleration performance of the first motor is secured referring to the performance curve of the first motor.

3. The engine stop control system of claim 1, wherein:
when the hybrid vehicle is driven on a downhill road having a low driving resistance, the hybrid control unit determines that the acceleration performance is secured in accordance with the gradient of the road.

4. The engine stop control system of claim 3, wherein:
the driving resistance includes a rolling resistance, an air resistance, and a slope resistance which accelerates the hybrid vehicle on the downhill road.

5. The engine stop control system of claim 1, wherein:
in a sport mode which requires a rapid acceleration response, the hybrid control unit does not apply the charging torque to the second motor.

6. The engine stop control system of claim 1, wherein:
the final second motor charging torque command is reset to approximate the charging torque command as the available torque is increased and reset to approximately zero as the available torque is reduced.

7. The engine stop control system of claim 1, wherein:
the final second motor charging torque command is reset to approximate the charging torque command as a gradient of the downhill road is increased and reset to approximately zero as the gradient of the downhill road is reduced,

8. The engine stop control system of claim 1, wherein:
the final second motor charging torque command is reset as a value obtained by adding a value mapped to the available torque of the first motor and a value which is mapped to a road gradient.

9. An engine stop control method of a hybrid vehicle which enters an electric vehicle (EV) mode while being driven in an HEV mode, the method comprising the steps of:
a) stopping starting of an engine and disengaging the engine and a driving shaft;
b) setting a charging torque command at which a maximum charging power is obtained in accordance with a speed of a second motor;
c) applying values which are mapped to an available torque of a first motor and variable factors of a road gradient to the charging torque command to reset the charging torque command as a final second motor charging torque command; and
applying the final second motor charging torque command to the second motor to stop the engine and collect the generated energy.

10. The engine stop control method of claim 9, wherein:
between step a) and step b), when the hybrid vehicle is in a sport mode which requires a rapid acceleration response, the charging torque is not applied to the second motor.

11. The engine stop control method of claim 9, wherein:
in step c), the final second motor charging torque command is reset to approximate the charging torque command as the available torque is increased and reset to approximately zero as the available torque is reduced.

12. The engine stop control method of claim 9, wherein:
in step c), the final second motor charging torque command is reset to approximate the charging torque command as a gradient of the downhill road is increased and reset to approximately zero as the gradient of the downhill road is reduced.

13. The engine stop control method of claim 9, wherein:
in step c), the final second motor charging torque command is reset as a value obtained by adding a value mapped to the available torque of the first motor and a value which is mapped to the road gradient.

14. The engine stop control method of claim 9, wherein:
after step d), when a driver requests reacceleration, the engine is connected to the driving shaft by raising an engine speed by the second motor while performing the reacceleration starting using the available torque of the first motor.

15. A non-transitory computer readable medium containing program instructions executed by a processor, the computer readable medium comprising:
program instructions that stop starting of an engine and disengage the engine and a driving shaft;
program instructions that set a charging torque command at which a maximum charging power is obtained in accordance with a speed of a second motor;
program instructions that apply values which are mapped to an available torque of a first motor and variable factors of a road gradient to the charging torque command to reset the charging torque command as a final second motor charging torque command; and
program instructions that apply the final second motor charging torque command to the second motor to stop the engine and collect the generated energy.
